(19) United States
(12) Patent Application Publication
(10) Pub. No.: US 2007/0139974 A1
(43) Pub. Date: Jun. 21, 2007

(54) High-voltage power supply device and image forming apparatus

(75) Inventors: Yukihiro Aikawa, Osaka-shi (JP); Yoshihiro Tohnai, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/601,996

(22) Filed: Nov. 20, 2006

(30) Foreign Application Priority Data
Nov. 25, 2005 (JP) 2005-340505
Nov. 2, 2006 (JP) 2006-299415

(51) Int. Cl. H02M 3/335

(52) U.S. Cl. 363/16

(57) ABSTRACT

A high-voltage power supply device for generating a voltage in which a direct-current voltage and an alternating-current voltage are superimposed is provided with alternating-current voltage generating unit generating an alternating-current voltage, and direct-current voltage generating unit generating a direct-current voltage to be superimposed on the alternating-current voltage generated by the alternating-current voltage generating unit. The alternating-current voltage generating unit sets the alternating-current voltage to be generated to such a value that peak values of a voltage superimposed with the direct-current voltage to fall within predetermined voltage values when generating the alternating-current voltage to start the superimposition with the direct-current voltage generated by the direct-current voltage generating unit.

### BACKGROUND OF THE INVENTION

1. Field of the Invention

The present invention relates to a high-voltage power supply device for generating a voltage in which a direct-current voltage is superimposed on an alternating-current voltage and an image forming apparatus provided with such a power supply device.

2. Description of the Related Art

An electrophotographic image forming apparatus is provided with a high-voltage power supply device for charging an image bearing member or for a developing bias. As such a high-voltage power supply device, the one for outputting a voltage in which a DC (direct-current) voltage is superimposed on an AC (alternating current) voltage has been used. For example, a high voltage in which an AC voltage and a DC voltage are superimposed is generated at a high-voltage output side of a secondary winding of an AC transformer for generating an AC voltage by connecting a DC power source for generating a DC high voltage between a low-voltage side of the secondary winding of the AC transformer and a ground. In this high-voltage power supply device, a primary side of the AC transformer is driven by a power amplifier and the frequency and duty ratio of a secondary side of the AC transformer are adjusted by adjusting the frequency and duty ratio of a pulse signal inputted to the power operational amplifier. Such a high-voltage power supply device is disclosed in Japanese Unexamined Patent Publication No. H06-202453.

If the DC voltage and the AC voltage are superimposed as described above, the amplitude of a resulting output voltage is increased by the output of the AC transformer at both sides of the voltage generated by the DC power source. At this time, the voltage becomes unstable upon the start of the superimposition of the DC voltage and the AC voltage, whereby a maximum value (or minimum value) of the superimposed output voltage exceeds (falls below) a leak voltage value and spark discharge occurs in some cases. An occurrence of such spark discharge may lead to the malfunction of a machine or the damage (pinhole) of a photoconductive drum.

### SUMMARY OF THE INVENTION

An object of the present invention is to solve problems as above and to remove the causes of the malfunction of a machine and the damage of a photoconductive drum by preventing an occurrence of spark discharge at the start of the superimposition of a DC voltage and an AC voltage.

Specifically, the present invention is directed to a high-voltage power supply device for generating a voltage in which a direct-current voltage and an alternating-current voltage are superimposed, comprising alternating-current voltage generating unit generating an alternating-current voltage and direct-current voltage generating unit generating a direct-current voltage to be superimposed on the alternating-current voltage generated by the alternating-current voltage generating unit, wherein the alternating-current voltage generating unit sets the alternating-current voltage to be generated to such a value that peak values of a voltage superimposed with the direct-current voltage fall within predetermined leak voltage values when generating the alternating-current voltage to start the superimposition with the direct-current voltage generated by the direct-current voltage generating unit.

With this construction, an occurrence of spark discharge at the start of the superimposition is prevented by the alternating-current voltage generating unit setting the alternating-current voltage to be generated to such a value that the peak values of the voltage superimposed with the direct-current voltage fall within the leak voltage values when the superimposition of the alternating-current voltage and the direct-current voltage is started.

Thus, according to the present invention, the causes of the malfunction of a machine and the damage of a photoconductive drum can be removed, and a voltage necessary for the image formation can be ensured. Further, power is not wastefully consumed since the peak values of the superimposed voltage are suppressed within the leak voltage values without incorporating a high-voltage constant voltage element to prevent the leakage.

According to the present invention, the alternating-current voltage may be either one of an alternating-current voltage and an alternating-current component and the direct-current voltage may be either one of a direct-current voltage and a direct-current component.

### BRIEF DESCRIPTION OF THE DRAWINGS

FIG. 1 is a front view in section showing one embodiment of a printer to which a high-voltage power supply device according to the invention is applied

FIG. 2 is a side view in section of a developing device.

FIG. 3 is a schematic construction diagram of the high-voltage power supply device according to the embodiment of the invention.

FIG. 4A is a chart showing the waveform of a voltage generated by superimposing a DC voltage on an AC voltage from the start of the superimposition on, FIG. 4B is a chart showing the waveform of a pulse outputted from a pulse oscillating section, and FIG. 4C is a chart showing the level of a control voltage outputted from a control voltage outputting section from the start of the superimposition on.

FIG. 5 is a graph showing another example of the level of the control voltage outputted from the control voltage outputting section.

FIG. 6 is a schematic construction diagram of a high-voltage power supply device according to a second embodiment.

FIG. 7A is a chart showing the waveform of a voltage generated by superimposing a DC voltage on an AC voltage in a conventional high-voltage power supply device from the start of the superimposition on, and FIG. 7B is a chart showing the waveform of a voltage generated by superimposing a DC voltage on an AC voltage in a high-voltage power supply device according to the embodiment of the invention from the start of the superimposition on.

### DETAILED DESCRIPTION OF THE PREFERRED EMBODIMENTS

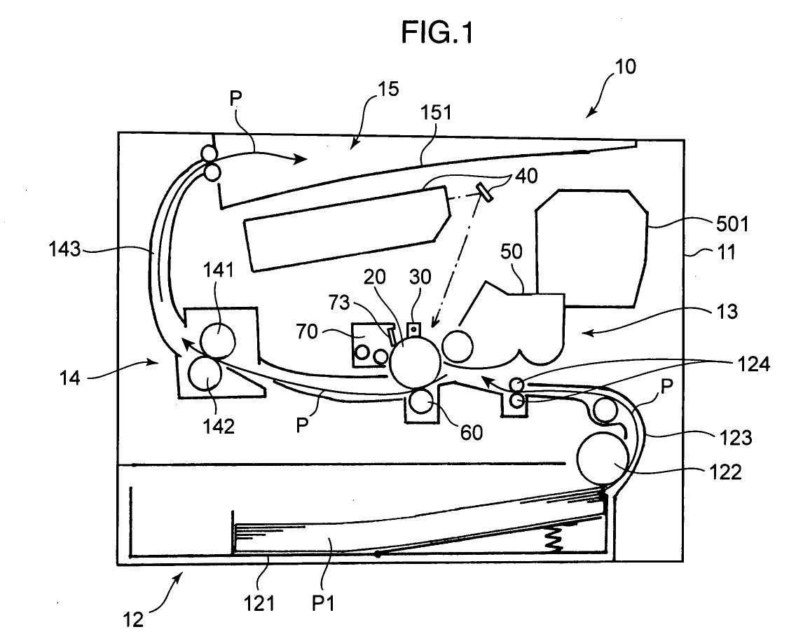

Hereinafter, a high-voltage power supply device and an image forming apparatus according to one embodiment of the present invention are described with reference to the accompanying drawings. FIG. 1 is a front view in section showing one embodiment of a printer to which the high-voltage power supply device according to the invention is applied. As shown in FIG. 1, in a printer (one example of the image forming apparatus according to one embodiment of the present invention) 10, a sheet storing unit 12 for storing sheets P used for printing, an image forming unit 13 for transferring an image to each one of sheets P disposed one by one from a sheet stack P1 stored in the sheet storing unit 12, and a fixing unit 14 for fixing the image transferred to the sheet P in the image forming unit 13 to the sheet P are provided in an apparatus main body 11, and a sheet discharge unit 15 to which the sheet P having the image fixed thereto in the fixing unit 14 is discharged is provided atop the apparatus main body 11.

The sheet storing unit 12 includes a specified number of (one in this embodiment) sheet cassette(s) 121 detachably mountable into the apparatus main body 11. A pickup roller 122 for dispensing the sheets P one by one from the sheet stack P1 is disposed at an upstream end (right side of FIG. 1) of the sheet cassette 121. The sheet P dispensed from the sheet cassette 121 by driving this pickup roller 122 is fed to the image forming unit 13 via a feeding conveyance path 123 and a pair of registration rollers 124 disposed at a downstream end of the feeding conveyance path 123.

The image forming unit 13 is for applying an image transferring operation to the sheet based on image information electrically transmitted from a computer or the like, and is constructed such that a charging device 30, an exposing device 40, a developing device 50, a transfer roller 60 and a cleaning device 70 are arranged in clockwise direction along the outer circumferential surface of a photoconductive drum 20 disposed rotatably about a drum shaft extending in forward and backward directions (directions normal to the plane of FIG. 1) from a position right above the photoconductive drum 20.

The photoconductive drum 20 is for forming an electrostatic latent image on the outer circumferential surface thereof and then forming a toner image in conformity with this electrostatic latent image. An amorphous silicon layer is formed on the outer circumferential surface of the photoconductive drum 20 so as to be suitable for forming these images. Such a photoconductive drum 20 is concentrically and integrally supported on the drum shaft extending in forward and backward directions (directions normal to the plane of FIG. 1) substantially in the center of the apparatus main body 11, and is rotatable together with the drum shaft driven to rotate clockwise by unillustrated driving unit.

The charging device 30 is for uniformly charging the outer circumferential surface of the photoconductive drum 20 rotating in clockwise direction about the central axis thereof. The charging device 30 performs charging by the corona discharge method for imparting electric charges to the outer circumferential surface of the photoconductive drum 20 through corona discharge from a wire.

The exposing device 40 emits a laser beam modulated based on an image data electrically transmitted from an external apparatus such as a computer to the outer circumferential surface of the rotating photoconductive drum 20, and an electrostatic latent image is formed on this outer circumferential surface by removing the electric charges in parts irradiated with the laser beam.

The developing device 50 is for attaching toner to the parts of the outer circumferential surface of the photoconductive drum 20 where the electrostatic latent image is formed by supplying the toner as a developer to this outer circumferential surface, thereby forming a toner image on the outer circumferential surface of the photoconductive drum 20. In this embodiment, so-called one-component toner comprised only of toner is used as a developer. According to the present invention, the developer is not limited to the one-component toner comprised only of toner, and may be two-component toner comprised of toner and carrier.

The transfer roller 60 is for transferring the positively charged toner image formed on the outer circumferential surface of the photoconductive drum 20 to the sheet P fed to the position right below the photoconductive drum 20, and imparts negative electric charges having polarity opposite to those of the toner image to the sheet P.

Accordingly, the positively charged toner image formed on the outer circumferential surface of the photoconductive drum 20 is separated toward the front side of the negatively charged sheet P while the sheet P having passed the position right below the photoconductive drum 20 is pressed between the transfer roller 60 and the photoconductive drum 20. In this way, an image transferring operation is applied to the sheet P.

The cleaning device 70 is for cleaning the outer circumferential surface of the photoconductive drum 20 by removing the residual toner on the outer circumferential surface of the photoconductive drum 20 after the image transferring operation. The outer circumferential surface of the photoconductive drum 20 cleaned by the cleaning device 70 heads toward the charging device 30 again for a next image forming operation.

The fixing unit 14 is for fixing the toner image transferred to the sheet P in the image forming unit 13 by heating and includes a heating roller 141 having an electric heating element such as a halogen lamp mounted therein, and a pressure roller 142 whose outer circumferential surface is opposed to that of the heating roller 141 from below. The sheet P after the image transferring operation receives heat from the heating roller 141 to have the toner image fixed by passing a nip between the heating roller 141 drivingly rotated in clockwise direction about its central axis and the pressure roller 142 driven to rotate in counterclockwise direction about its central axis. The sheet P having the image fixing operation applied thereto is discharged to the sheet discharging unit 15 through a discharging conveyance path 143.

The sheet discharging unit 15 is formed by recessing the top of the apparatus main body 11, and a sheet discharge tray 151 for receiving the discharged sheet P is formed at the bottom of the thus formed recess.

In this printer 10, the high-voltage power supply device according to one embodiment of the present invention is employed for the output of a high voltage as a developing bias of the developing device 50 (as described later). It may also be employed for the output of a charging high voltage of the charging device 30 (as described later).

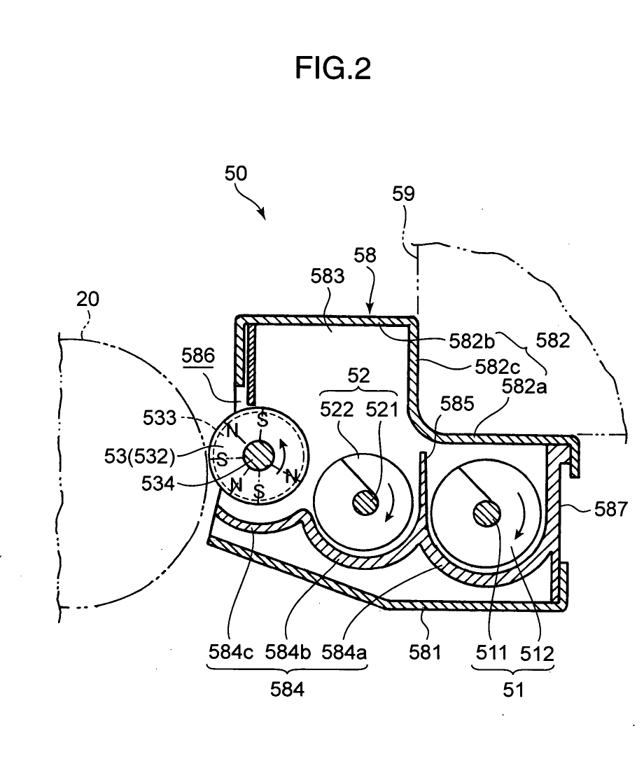

FIG. 2 is a side view in section of the developing device 50. The developing device 50 is constructed such that a first spiral feeder 51 for conveying toner supplied from a toner cartridge 59 backward while agitating the toner, a second spiral feeder 52 for conveying the toner transferred from the first spiral feeder 51 forward and a development sleeve 53 for receiving the toner being conveyed by the second spiral feeder 52 and supplying it to a latent-image region on the outer circumferential surface of the photoconductive drum 20 are mounted in a casing 58.

The casing 58 has a bottom plate 581 that is inclined upward to the left from a substantially transverse middle position in FIG. 2 so that the left end thereof faces the photoconductive drum 20, a ceiling plate 582 provided at the top and opposed to the bottom plate 581, a pair of side plates 583 spaced apart in forward and backward directions and spanning between the front ends and between the rear ends of the bottom plate 581 and the ceiling plate 582, and a toner receiving tray 584 spanning between this pair of side plates 583.

The ceiling plate 582 has a stepped shape by having the left side considerably higher and is comprised of a lower ceiling plate 582a at the right side, a higher ceiling plate 582b at the left side, and a vertical ceiling plate 582c spanning between the left edge of the lower ceiling plate 582a and the right edge of the higher ceiling plate 582b. A toner receiving port (not shown) is formed in a front end portion of the lower ceiling plate 582a to receive the toner. A toner supply port 586 for supplying the toner in the casing 58 to the outer circumferential surface of the photoconductive drum 20 by facing the outer circumferential surface of the photoconductive drum 20 is formed between the left edge of the higher ceiling plate 582b and the right edge of the bottom plate 581.

The toner receiving tray 584 is comprised of a first tray 584a for accommodating the first spiral feeder 51, a second tray 584b for accommodating the second spiral feeder 52, and a third tray 584c opposed to the development sleeve 53 from below. The first to third trays 584a to 584c are all formed to have arcuate front views so as to conform to the corresponding first and second spiral feeders 51, 52 and development sleeve 53. A right wall 587 is provided at the right end of the first tray 584a. The right surface in the casing 58 is closed by this right wall 587 spanning between the right ends of the bottom plate 581 and the lower ceiling plate 582a.

The first spiral feeder 51 is comprised of a first feeder shaft 511 penetrating the pair of side plates 683 to span therebetween at a position right above the first tray 584a, and a first spiral fin 512 concentrically fixed to the outer circumferential surface of the first feeder shaft 511. The first spiral fin 512 is spirally formed to construct a left-hand thread, and conveys the toner on the first tray 584a backward by the clockwise rotation of the first feeder shaft 511 in front view.

The second spiral feeder 52 is comprised of a second feeder shaft 521 penetrating the pair of side plates 583 to span therebetween at a position right above the second tray 584b, and a second spiral fin 522 concentrically fixed to the outer circumferential surface of the second feeder shaft 521. The second spiral fin 522 is spirally formed to construct a right-hand thread, and conveys the toner on the second tray 584b forward by the clockwise rotation of the second feeder shaft 521 in front view.

A partition wall 585 is provided between the first and second trays 584a, 584b. A front circulation port (not shown) is formed at a front position of this partition wall 585 and a rear circulation port (not shown) is formed at a rear position thereof. The toner introduced into the casing 58 through a toner receiving port from the toner cartridge 59 is conveyed backward by the driving rotation of the first spiral feeder 51 in the first tray 584a, introduced into the second tray 584b through the back circulation port, and conveyed forward by the driving rotation of the second spiral feeder 52 in the second tray 584b. Thereafter, the toner is supplied to the development sleeve 53 while being circulated between the first and second trays 584a, 584b.

The development sleeve 53 is comprised of a sleeve shaft 534 penetrating the pair of side plates 583 to span therebetween and a sleeve main body 532 concentrically and relatively rotatably fitted on the sleeve shaft 534. The development sleeve 53 is set at such a position above the third tray 584c that the outer circumferential surface of the sleeve main body 532 faces that of the photoconductive drum 20 through the toner supply port 586 and is rotated in counterclock direction in FIG. 2 about the sleeve shaft 534 by being driven by unillustrated driving unit, whereby the toner conveyed to the third tray 584c is fed to the outer circumferential surface of the photoconductive drum 20.

In the developing device 50, the toner is agitated by the agitating action of the first and second spiral feeders 51, 52 to be positively (+) charged. A bias voltage in which an AC bias is superimposed on a DC bias is applied to the development sleeve 53 by the high-voltage power supply device to be described later. The positively (+) charged electrostatic latent image formed on the photoconductive drum 20 is reversely developed with the developer conveyed by being held by the magnetic force of the development sleeve 53, whereby a toner image is formed on the outer circumferential surface of the photoconductive drum 20.

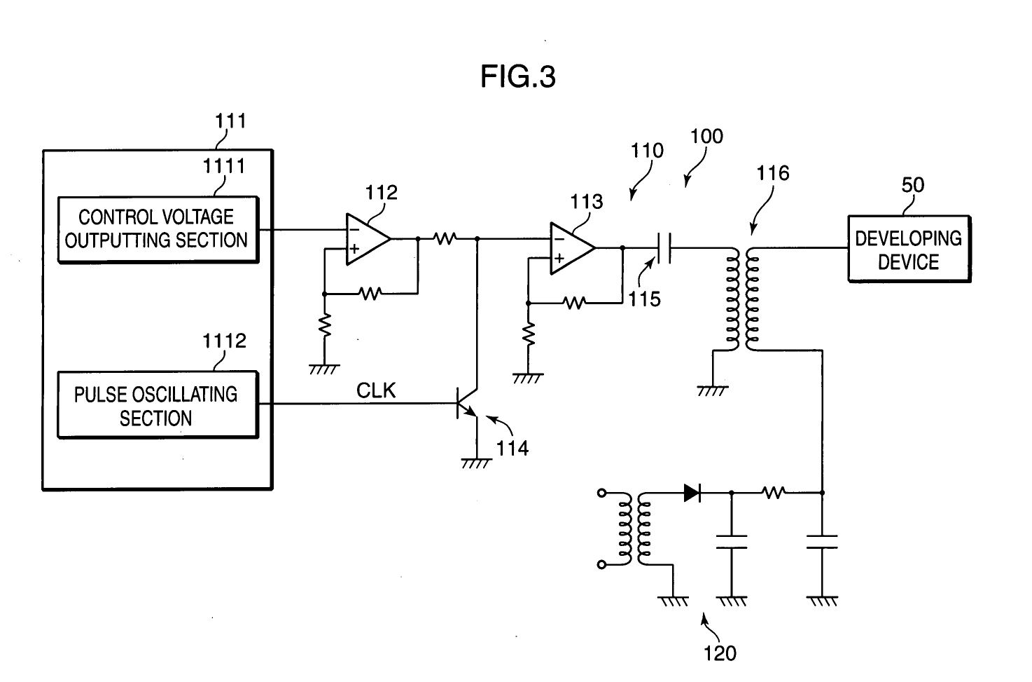

FIG. 3 is a schematic construction diagram of the high-voltage power supply device according to a first embodiment of the present invention. A high-voltage power supply device 100 is provided with an AC (alternating current) bias generating circuit 110 and a DC (direct current) bias generating circuit 120.

The AC bias generating circuit (alternating-current voltage generating unit) 110 is a circuit for generating a high AC voltage (or AC component, means the same below). The AC bias generating circuit 110 includes a control circuit 111, an operational amplifier 112, a power operational amplifier 113, a switching element 114, a capacitor 115 and a transformer 116.

The control circuit 111 controls on-off of the application of the AC voltage and controls the amplitude of the AC voltage. The control circuit 111 includes a control voltage outputting section 1111 and a pulse oscillating section 1112. The control voltage outputting section (amplitude controller) 1111 is for outputting a control voltage for adjusting the value of a current driven by the operational amplifier 112 after varying it. The control voltage outputting section 1111 varies the amplitude of an alternating-current voltage amplified by the operational amplifier 112 and fed to the transformer 116 via the power operational amplifier 113 and the capacitor 115 by changing the level of this control voltage. In other words, the control voltage outputting section 1111 increases the amplitude of the alternating-current voltage by increasing the level of the control voltage while decreasing the amplitude of the alternating-current voltage by decreasing the level of the control voltage.

The operational amplifier 112 is for amplifying the control voltage outputted from the control voltage outputting section 1111, thereby approximating the control voltage to a voltage level required for a developing bias of the developing device 50. The pulse oscillating section 1112 oscillates a pulse for the switch control as to whether or not the voltage amplified by the operational amplifier 112 is outputted to the operational amplifier 113.

Whether or not the control voltage amplified by the operational amplifier 112 is fed to the power operational amplifier 113 is switched by turning the switching element 114 on or off in response to the pulse oscillated by the pulse oscillating section 1112. The control voltage amplified by the operational amplifier 112 is fed to the transformer 116 via the power operational amplifier 113 and the capacitor 115. Specifically, the control voltage outputted from the control voltage outputting section 1111 is amplified by the operational amplifier 112, and this amplified voltage is outputted to the power operational amplifier 113 in specified cycles by the pulse oscillating section 1112, whereby an AC voltage is generated.

The DC bias generating circuit (direct-current voltage generating unit) 120 is a circuit for generating a high DC voltage (or DC component, means the same below). The DC bias generating circuit 120 is connected between a low voltage side of a secondary winding of the transformer 116 for generating the AC voltage and a ground. In this way, a voltage in which the AC voltage and the DC voltage are superimposed is generated at a high voltage output side of the secondary winding of the transformer 116. The voltage superimposed in this way is applied to the developing device 50 (development sleeve 53).

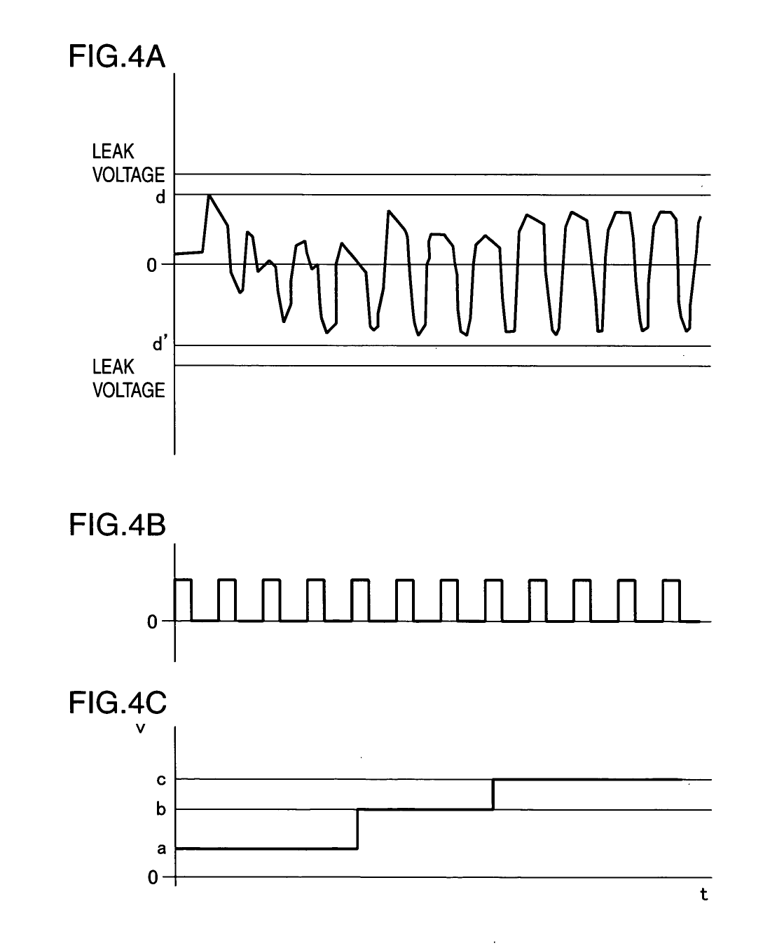

The voltage application control by the high-voltage power supply device 100 constructed as above is described. FIG. 4A is a chart showing the waveform of a voltage in which an AC voltage and a DC voltage are superimposed from the start of the superimposition on, FIG. 4B is a chart showing the waveform of a pulse outputted from the pulse oscillating section 1112, and FIG. 4C is a chart showing the level of a control voltage outputted from the control voltage outputting section 1111 from the start of the superimposition on. The voltage application control by the high-voltage power supply device 100 is described with reference to FIGS. 4 and 3.

In the high-voltage power supply device 100, the level of the control voltage outputted from the control voltage outputting section 1111 of the control circuit 111 is set low at the start of the superimposition of the AC voltage and the DC voltage and is increased stepwise with time up to a level used for the image formation as shown in FIG. 4C.

When the superimposition of the pulsed AC voltage and the DC voltage is started upon the start of the pulse output from the pulse oscillating section 1112, peak values of the voltage after the superimposition of the DC voltage of the DC bias generating circuit 120 are set at such levels as not to reach leak voltages (set by being detected beforehand by actual measurements and the like based on the used AC voltage, DC voltage, control voltage, and conditions of the operational amplifier 112, the power operational amplifier 113 and the like) as shown in FIG. 4A. For example, the control voltage outputted from the control voltage outputting section 1111 is set at low level “a” (see FIG. 4C).

The AC voltage is outputted in response to the control voltage having the level “a” at the start of the superimposition. Then, after the DC voltage of the DC bias generating circuit 120 is superimposed, and the voltage outputted from the control voltage outputting section 1111 has the level thereof increased up to level “b” as shown in FIG. 4C at a timing at which the superimposed voltage converges and stabilizes. The control voltage level “b” at this point of time is an intermediate level between the control voltage level “c” used for the image formation and the control voltage level “a” at the start of the superimposition.

A value for increasing the control voltage at this point of time may be increased by an amount in conformity with a smaller one of differences between a maximum value and a minimum value of the voltage superimposed with the DC voltage and leak voltage values (values supposed as leak voltages of the superimposed voltage in the case where the control value level “c” is used) corresponding to these minimum and maximum values. With such an arrangement, the voltage superimposed with the DC voltage does not reach beyond the leak voltage values even if the amplitude of the AC voltage outputted from the AC bias generating circuit 110 is increased through an increase of the level of the control voltage by the control value outputting section 1111.

The control voltage level “a” at the start of the superimposition is suppressed to such a low level that the voltage after the superimposition of the DC voltage does not reach the leak voltages. Thus, the voltage after the superimposition of the DC voltage is not suitable for the output of a high voltage as a developing bias at the time of the image formation. Therefore, the control voltage level is increased to the level “b” as shown in FIG. 4C, whereby the voltage after the superimposition of the DC voltage can be approximated to an ideal value (voltage average value is equal to the value of the DC voltage applied for the superimposition) used for the output of the high voltage as a developing bias for the image formation as shown in FIG. 4A.

After the AC voltage is outputted in response to the control voltage increased to the above level “b” and the DC voltage is superimposed, the voltage outputted from the control voltage outputting section 1111 is further increased to level “c” as shown in FIG. 4C at a timing at which the superimposed voltage converges and stabilizes. The control voltage level at this point of time is a control voltage level used for the image formation. In this way, as shown in FIG. 4A, the voltage after the superimposition of the DC voltage can be approximated to an ideal value (voltage average value is equal to the value of the DC voltage applied for the superimposition) used for the output of the high voltage as a developing bias for the image formation.

Regardless of which of the above levels of the control voltage is used, positive and negative peak values of the superimposed voltage are preferably suppressed to voltage values (d′ to d) of the levels lower and higher than the positive and negative leak voltages with margins, respectively.

In the above description, the control voltage outputted from the control voltage outputting section 1111 at the start of the superimposition is set at a level that is lower than the one used for the image formation and will cause the peak values of the superimposed voltage to fill within the leak voltages. In addition, the control voltage outputted from the control voltage outputting section 1111 may be decreased to a level lower than the one used for the image formation immediately before the end of the superimposition, and the superimposition may be ended after the peak values of the superimposed voltage fall within the leak voltages. With such an arrangement, even if the superimposed voltage becomes unstable to suddenly change the voltage, problems such as spark discharge can be prevented and the causes of the malfunction of a machine and the damage of a photoconductive drum can be removed.

The aforementioned level control of the control voltage by unit of the control voltage outputting section 1111 is preferably executed by the control circuit 111 in accordance with a program (it is programmed, for example, the control voltage of which level is outputted at which timing) stored in a ROM (not shown) or the like provided in the control circuit 111 for the control voltage level control. However, a method for executing the level control of the control voltage is not limited to this.

As described above, problems such as spark discharge can be prevented even if the voltage suddenly changes at the start of the superimposition and the causes of the malfunction of a machine and the damage of a photoconductive drum can be removed by setting the control voltage outputted from the control voltage outputting section 1111 to such a level that is lower than the one used for the image formation and will cause the peak values of the superimposed voltage to fall within the leak voltages and then gradually increasing the level of the control voltage to set the superimposed voltage to a voltage used for the image formation. Further, a voltage necessary for the image formation can be ensured. Further, power is not wastefully consumed since the peak values of the superimposed voltage are suppressed within the leak voltage values without incorporating a high-voltage constant voltage element to prevent the leakage.

If the superimposition is performed using an AC voltage having voltage values not reaching beyond the leak voltages at the start of the superimposition, an occurrence of the spark discharge can be prevented, but there is a problem of being unable to increase the superimposed voltage up to the value of the level necessary for the image formation. However, according to the present invention, this problem does not arise since a control is executed to obtain the necessary superimposed voltage at the time of the image formation while preventing the voltage value from reaching beyond the leak voltages at the start of the superimposition.

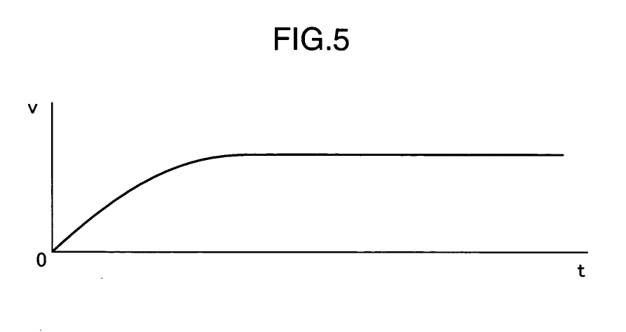

The present invention is not limited to the construction of the first embodiment and various changes can be made. For example, the level of the control voltage is changed in three steps by the control voltage outputting section 1111 of the control circuit 111 (see FIG. 4C) in the first embodiment, but the level of the control voltage may be changed in a plurality of different steps. Instead of the stepwise change, the level of the control voltage may be increased continuously or in a nonstepwise manner as shown in FIG. 5.

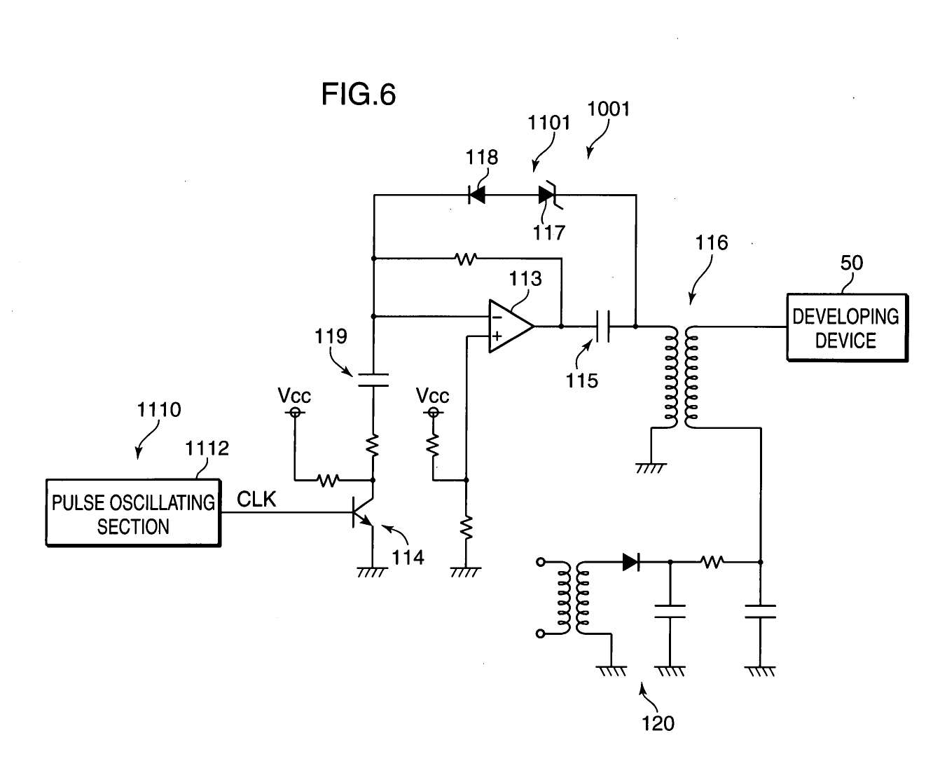

Next, a high-voltage power supply device according to a second embodiment of the present invention is described. FIG. 6 is a schematic construction diagram showing the high-voltage power supply device according to the second embodiment of the present invention. It should be noted that the construction similar to that of the first embodiment shown in FIG. 3 is not described by being identified by the same reference numerals.

A high-voltage power supply device 1001 according to the second embodiment is provided with an AC (alternating current) bias generating circuit 1101 and a DC (direct current) bias generating circuit 120.

The AC bias generating circuit (alternating-current voltage generating unit) 1101 includes a control circuit 1110, a power operational amplifier 113, a switching element 114, a capacitor 115 and a transformer 116. Further, the AC bias generating circuit 1101 is connected with, for example, a pullup resistor.

The control circuit 1110 has a pulse oscillating section (duty ratio controller) 1112 for on-off controlling the application of the AC voltage. The switching element 114 is turned on and off in response to a pulse oscillated by the pulse oscillating section 1112, wherein a Low-level voltage is outputted to the power operational amplifier 113 when the switching element 114 is on and a High-level voltage is outputted to the power operational amplifier 113 when the switching element 114 is off The low-level voltage and the High-level voltage are amplified in an operational amplifier 112, and the AC voltage is generated in the transformer 116. The pulse oscillating section 1112 can vary the duty ratio of the pulse to be oscillated. It should be noted that the control circuit 1110 of the high-voltage power supply device 1001 according to the second embodiment requires no control voltage outputting section 1111.

Further, a zener diode 117 is connected to face in a direction shown in FIG. 6 at an output side of the power operational amplifier 113 and between the capacitor 115 and the transformer 116. This zener diode 117 is connected in series with a diode 118 facing in a direction opposite to that of the zener diode 117. The diode 118 is connected with a inverting input terminal of the power operational amplifier 113. The zener diode 117 has a zener voltage for suppressing the AC voltage generated in the transformer 116 to such a value that the voltage after the superimposition of the AC voltage generated in the transformer 116 and a DC voltage generated in the DC bias generating circuit 120 falls within the leak voltage values.

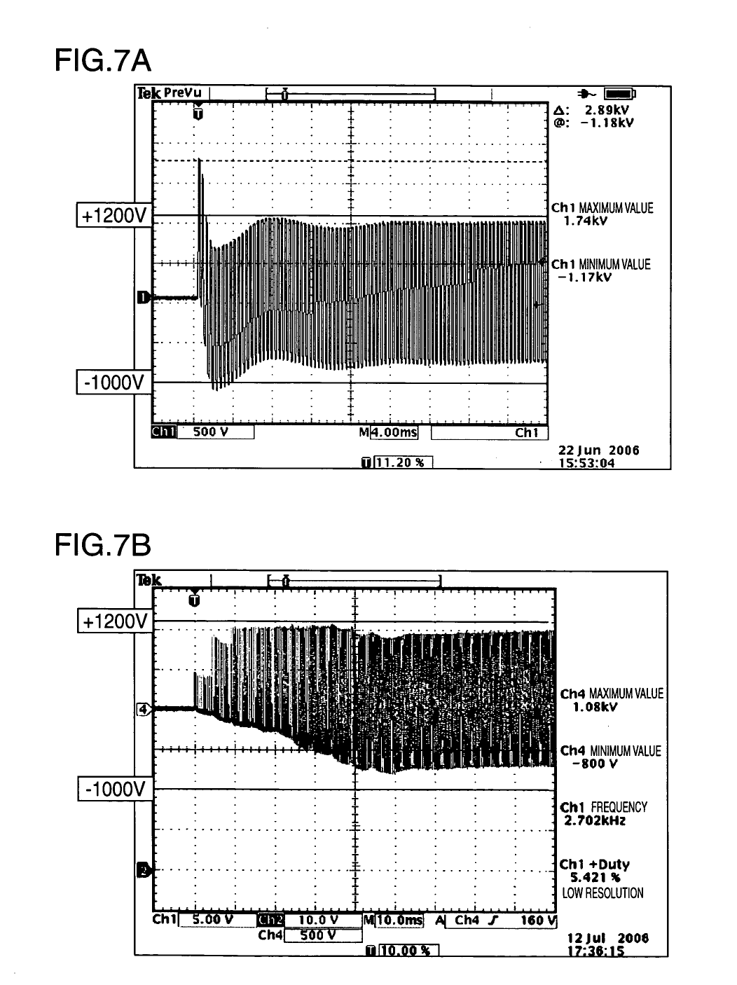

The voltage application control by the high-voltage power supply device 1001 constructed as above is described. FIG. 7A is a chart showing the waveform of a voltage in which a DC is superimposed on an Ac voltage in a conventional high-voltage power supply device from the start of the superimposition on, and FIG. 7B is a chart showing the waveform of the voltage in which a DC voltage is superimposed on an AC voltage in the high-voltage power supply device 1001 from the start of the superimposition on. The voltage application control by the high-voltage power supply device 1001 is described with reference to FIGS. 7 and 6.

In the high-voltage power supply device 1001, the pulse oscillating section 1112 sets the duty ratio of the pulse to be outputted lower than the one used for the image formation at the start of the superimposition of the AC voltage and the DC voltage and gradually increases this duty ratio with time up to a level used for the image formation within a predetermined period. The pulse oscillating section 1112 causes the duty ratio to reach up to the level used for the image formation at a timing at which the superimposed voltage converges and stabilizes. For example, if the duty ratio used for the image formation is 50%, the pulse oscillating section 1112 sets the duty ratio to 5% at the start of the superimposition of the AC voltage and the DC voltage and increases it by 5% at every interval of 5 msec. In other words, the pulse oscillating section 1112 increases the duty ratio from 5% to 50% used for the image formation during a period of 45 msec following the start of the superimposition.

The control of the duty ratio by unit of the pulse oscillating section 1112 is preferably executed by the control circuit 111 in accordance with a program (it is programmed, for example, which duty ratio is set at which timing) stored in a ROM (not shown) provided in the control circuit 111 for the duty ratio control. However, a method for executing the control of the duty ratio is not limited to this.

Since the zener diode 117 is connected at the output side of the power operational amplifier 113 and between the capacitor 115 and the transformer 116 as described above, the voltage outputted from the power operational amplifier 113 is suppressed to the zener voltage of the zener diode 117. The zener voltage of the zener diode 117 is set to fall within the leak voltage values of the voltage after the superimposition of the AC voltage and the DC voltage by actual measurements or the like based on the used AC voltage, DC voltage and conditions of the power operational amplifier 113 and the like.

In the case of the conventional high-voltage power supply device, the voltage becomes unstable and the maximum (or minimum) value of the superimposed output voltage may exceed (fall below) the leak voltage value at both plus and minus sides during a specified period following the start of the superimposition as shown in FIG. 7A when the DC voltage is superimposed on the AC voltage. However, in the high-voltage power supply device 1001, the pulse oscillating section 1112 variably controls the duty ratio of the output pulse as described above, whereby the voltage after the superimposition does not reach the leak voltage (shown by −1000 V) at the minus side as shown in FIG. 7B through the smoothing by the capacitor 115. Further, in the high-voltage power supply device 1001, the voltage after the superimposition at the plus side does not reach the leak voltage (shown by 1200 V) as shown in FIG. 7B due to the presence of the zener diode 117.

In the case of the high-voltage power supply device 100 according to the first embodiment, the control circuit 111 needs to be provided with the control voltage outputting section 1111. However, in the high-voltage power supply device 1001 according to the second embodiment, it is not necessary to provide the control voltage outputting section 1111 and sufficient to provide only the pulse oscillating section 1112. The superimposed voltage can be prevented from reaching the leak voltages at both plus and minus sides by the variable control of the duty ratio by unit of the pulse oscillating section 1112 and by the zener diode 117. Therefore, the superimposed voltage can be more inexpensively prevented from reaching the leak voltages by a simpler construction as compared to a case where the amplitude of the AC voltage used for the superimposition is variably controlled.

Although the zener diode 117 is connected at the output side of the operational amplifier 113, between the capacitor 115 and the transformer 116 and with the inverting input terminal of the power operational amplifier 113 in the second embodiment, the construction of the AC bias generating circuit 1101 is not limited thereto. For example, the zener diode 117 connected at the output side of the operational amplifier 113 and between the capacitor 115 and the transformer 116 may be grounded.

Further, in the second embodiment, the level of the voltage outputted to the power operational amplifier 113 is controlled between High-level and Low-level when the switching element 114 is turned on and off in response to the pulse oscillated by the pulse oscillating section 1112 by a pullup resistor connected with the AC bias generating circuit 1101. However, the construction of the AC bias generating circuit 1101 is not limited thereto. The level of the voltage outputted to the power operational amplifier 113 may be controlled between High-level and Low-level based on the pulse oscillated by the pulse oscillating section 1112b by another construction.

Although the high-voltage power supply devices 100, 1001 according to the first and second embodiments of the present invention are employed for the output of the high voltage as a developing bias of the developing device 50, application is not limited thereto. For example, the high-voltage power supply device 100 may be employed for the output of a charging high voltage of the charging device 30.

In the case where the high-voltage power supply device 100 according to the first embodiment is employed for the output of a charging high voltage of the charging device 30, the control voltage outputting section 1111 may, similar to the first embodiment, execute a control to: suppress the peak values of the voltage superimposed with the direct-current voltage within the predetermined leak voltage values by setting the amplitude of the alternating-current voltage to be generated smaller than the one used for the image formation when the superimposition of the alternating-current voltage and the direct-current voltage is started, and approximate the superimposed voltage to an ideal voltage value used for the image formation by increasing the amplitude of the alternating-current voltage to be generated when the voltage superimposed with the direct-current voltage converges.

In the case where the high-voltage power supply device 1001 according to the second embodiment is employed for the output of a charging high voltage of the charging device 30, the pulse oscillating section 1112 may, similar to the second embodiment, execute a control to: set the duty ratio of the output pulse smaller than the one used for the image formation when the superimposition of the alternating-current voltage and the direct-current voltage is started, and approximate the superimposed voltage to an ideal voltage value used for the image formation using the duty ratio of the output pulse as a duty ratio used for the image formation when the voltage superimposed with the direct-current voltage converges.

In short, the present invention is directed to a high-voltage power supply device for generating a voltage in which a direct-current voltage and an alternating-current voltage are superimposed comprising alternating-current voltage generating unit generating an alternating-current voltage and direct-current voltage generating unit generating a direct-current voltage to be superimposed on the alternating-current voltage generated by the alternating-current voltage generating unit, wherein the alternating-current voltage generating unit sets the alternating-current voltage to be generated to such a value that peak values of a voltage superimposed with the direct-current voltage fall within predetermined leak voltage values when generating the alternating-current voltage to start the superimposition with the direct-current voltage generated by the direct-current voltage generating unit.

With this construction, an occurrence of spark discharge at the start of the superimposition is prevented by the alternating-current voltage generating unit setting the alternating-current voltage to be generated to such a value that the peak values of the voltage superimposed with the direct-current voltage fall within the leak voltage values when the superimposition of the alternating-current voltage and the direct-current voltage is started.

Thus, according to the present invention, the causes of the malfunction of a machine and the damage of a photoconductive drum can be removed, and a voltage necessary for the image formation can be ensured. Further, power is not wastefully consumed since the peak values of the superimposed voltage are suppressed within the leak voltage values without incorporating a high-voltage constant voltage element to prevent the leakage.

Preferably, the alternating-current voltage generating unit includes an amplitude controller for controlling the amplitude of the alternating-current voltage to be generated, wherein the amplitude controller sets the amplitude of the alternating-current voltage to be generated to such a value that is smaller than the amplitude used for the image formation and that will cause the peak values of the voltage superimposed with the direct-current voltage to fall within the predetermined leakage voltage values when the alternating-current voltage generating unit generates the alternating-current voltage to start the superimposition with the direct-current voltage generated by the direct-current voltage generating unit.

With this construction, an occurrence of spark discharge at the start of the superimposition is prevented by setting the amplitude of the alternating-current voltage to such a value that is smaller than the amplitude used for the image formation and that will cause the peak values of the voltage superimposed with the direct-current voltage to fall within the predetermined leakage voltage values when the superimposition of the alternating-current voltage and the direct-current voltage is started. Thus, according to the present invention, the causes of the malfunction of a machine and the damage of a photoconductive drum can be removed, and a voltage necessary for the image formation can be ensured. Further, power is not wastefully consumed since the peak values of the superimposed voltage are suppressed within the leak voltage values without incorporating a high-voltage constant voltage element to prevent the leakage.

Preferably, the amplitude controller sets the amplitude of the alternating-current voltage to be generated by the alternating-current voltage generating unit smaller than the one used for the image formation when the superimposition is started and increases the amplitude of the alternating-current voltage to be generated up to such a value that the voltage superimposed with the direct-current voltage approximates to an ideal voltage value used for the image formation when the voltage superimposed with the direct-current voltage converges.

With this construction, the amplitude controller sets the amplitude of the alternating-current voltage smaller than the one used for the image formation when the superimposition of the alternating-current voltage and the direct-current voltage is started while increasing the amplitude of the alternating-current voltage to be outputted to approximate the voltage superimposed with the alternating-current voltage to the ideal voltage value used for the image formation, thereby ensuring the voltage necessary for the image formation, when the voltage superimposed with the direct-current voltage converges to the alternating-current voltage having the reduced amplitude. Thus, according to the present invention, the voltage necessary for the image formation can be ensured while an occurrence of spark discharge at the start of the output of the alternating-current voltage is prevented.

Preferably, the amplitude controller increases the amplitude of the alternating-current voltage to be generated in accordance with a smaller one of differences between maximum and minimum values of the voltage superimposed with the direct-current voltage and the respective leak voltage values when the voltage superimposed with the direct-current voltage converges.

With this construction, the voltage value does not reach beyond the leak voltage values even if the amplitude controller increases the amplitude of the alternating-current voltage since the amplitude of the alternating-current voltage to be outputted after the convergence of the superimposed voltage is increased in conformity with a smaller one of differences between maximum and minimum values of the voltage superimposed with the direct-current voltage and the respective leak voltage values. Thus, according to the present invention, it can be securely prevented for the superimposed voltage to reach beyond the leak voltage values even if the amplitude of the alternating-current voltage is increased.

Preferably, the amplitude controller sets the amplitude of the alternating-current voltage to such a value that is smaller than the amplitude used for the image formation and will cause the peak values of the voltage superimposed with the direct-current voltage to fall within the predetermined leakage voltage values immediately before the generation of the alternating-current voltage by the alternating-current voltage generating unit is ended.

With this construction, an occurrence of spark discharge at the end of the alternating-current voltage is prevented by the amplitude controller setting the amplitude of the alternating-current voltage to such a value that is smaller than the one used for the image formation and will cause the peak values of the voltage superimposed with the generated direct-current voltage to fall within the predetermined leakage voltage values immediately before the output of the alternating-current voltage by the alternating-current voltage generating unit is ended. Thus, according to the present invention, the causes of the malfunction of a machine and the damage of a photoconductive drum at the end of the output of the alternating-current voltage can be removed, and a voltage necessary for the image formation can be ensured. Further, power is not wastefully consumed since the peak values of the superimposed voltage are suppressed within the leak voltage values without incorporating a high-voltage constant voltage element to prevent the leakage.

The present invention is also directed to a high-voltage power supply device for generating a voltage in which a direct-current voltage and an alternating-current voltage are superimposed, comprising alternating-current voltage generating unit generating an alternating-current voltage and direct-current voltage generating unit generating a direct-current voltage to be superimposed on the alternating-current voltage generated by the alternating-current voltage generating unit, wherein the alternating-current voltage generating unit includes a duty ratio controller for varying the duty ratio of the alternating-current voltage to be generated and a zener diode having a zener voltage for suppressing the alternating-current voltage to be generated such that voltage superimposed with the direct-current voltage falls within predetermined leak voltage values, and the duty ratio controller sets the duty ratio of the alternating-current voltage at the start of the superimposition of the alternating-current voltage and the direct-current voltage to such a value that is smaller than the duty ratio used for the image formation and will cause the superimposed voltage to fall within the leak voltages.

With this construction, the duty ratio controller prevents the voltage at the minus side from reaching the leak voltage by setting the duty ratio of the alternating-current voltage at the start of the superimposition of the alternating-current voltage and the direct-current voltage to such a value that is smaller than the duty ratio used for the image formation and will cause the superimposed voltage to fall within the leak voltages. Further, the zener diode provided in the alternating-current voltage generating unit prevents the voltage at the plus side from reaching the leak voltage by suppressing the alternating-current voltage to such a value that the voltage after the superimposition falls below the leak value. In this way, an occurrence of spark discharge at the start of the superimposition is prevented. Thus, according to the present invention, an occurrence of spark discharge can be prevented, the causes of the malfunction of a machine and the damage of the photoconductive drum can be removed, and a voltage necessary for the image formation can be ensured. Further, these effects can be obtained more inexpensively by a simpler construction as compared to a case where the amplitude of the alternating-current voltage to be generated by the alternating-current voltage generating unit is varied.

Preferably, the duty ratio controller amplifies the duty ratio of the alternating-current voltage to the one used for the image formation from the one with which the voltage after the superimposition falls within the leak voltages within a predetermined period following the start of the superimposition of the alternating-current voltage and the direct-current voltage.

With this construction, the voltage necessary for the image formation is ensured by amplifying the duty ratio of the alternating-current voltage to the one used for the image formation from the one with which the voltage after the superimposition falls within the leak voltages within the predetermined period. Thus, leak voltages likely to occur over a predetermined period following the start of the superimposition can be securely prevented.

Preferably, a diode is connected in series with the zener diode.

With this construction, the flow of a current of an opposite direction can be prevented in a circuit part connected with the zener diode by the diode. Thus, an occurrence of spark discharge can be more securely prevented, thereby removing the causes of the malfunction of a machine and the damage of a photoconductive drum.

The present invention is further directed to an image forming apparatus comprising any one of the high-voltage power supply devices according to the present invention for the output of a high voltage as a developing bias.

The present invention is still further directed to an image forming apparatus comprising any one of the high-voltage power supply devices according to the present invention for the output of a charging high voltage.

This application is based on patent application No. 2005-340505 and No. 2006-299415 filed on Nov. 25, 2005 and Nov. 2, 2006 in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A high-voltage power supply device for generating a voltage in which a direct-current voltage and an alternating-current voltage are superimposed, comprising:
alternating-current voltage generating unit generating an alternating-current voltage, and
direct-current voltage generating unit generating a direct-current voltage to be superimposed on the alternating-current voltage generated by the alternating-current voltage generating unit,
wherein the alternating-current voltage generating unit sets the alternating-current voltage to be generated to such a value that peak values of a voltage superimposed with the direct-current voltage fall within predetermined leak voltage values when generating the alternating-current voltage to start the superimposition with the direct-current voltage generated by the direct-current voltage generating unit.

2. A high-voltage power supply device according to claim 1, wherein the alternating-current voltage generating unit includes an amplitude controller for controlling the amplitude of the alternating-current voltage to be generated, and the amplitude controller sets the amplitude of the alternating-current voltage to be generated to such a value that is smaller than the amplitude used for the image formation and that will cause the peak values of the voltage superimposed with the direct-current voltage to fall within the predetermined leakage voltage values when the alternating-current voltage generating unit generates the alternating-current voltage to start the superimposition with the direct-current voltage generated by the direct-current voltage generating unit.

3. A high-voltage power supply device according to claim 2, wherein the amplitude controller sets the amplitude of the alternating-current voltage to be generated by the alternating-current voltage generating unit smaller than the one used for the image formation when the superimposition is started and increases the amplitude of the alternating-current voltage to be generated up to such a value that the voltage superimposed with the direct-current voltage approximates to an ideal voltage value used for the image formation when the voltage superimposed with the direct-current voltage converges.

4. A high-voltage power supply device according to claim 3, wherein the amplitude controller increases the amplitude of the alternating-current voltage to be generated in accordance with a smaller one of differences between maximum and minimum values of the voltage superimposed with the direct-current voltage and the respective leak voltage values when the voltage superimposed with the direct-current voltage converges.

5. A high-voltage power supply device according to claim 2, wherein the amplitude controller sets the amplitude of the alternating-current voltage to such a value that is smaller than the amplitude used for the image formation and will cause the peak values of the voltage superimposed with the direct-current voltage to fall within the predetermined leakage voltage values immediately before the generation of the alternating-current voltage by the alternating-current voltage generating unit is ended.

6. A high-voltage power supply device according to claim 1, wherein:
the alternating-current voltage generating unit includes a duty ratio controller for varying the duty ratio of the alternating-current voltage to be generated and a zener diode having a zener voltage for suppressing the alternating-current voltage to be generated such that voltage superimposed with the direct-current voltage falls within predetermined leak voltage values, and
the duty ratio controller sets the duty ratio of the alternating-current voltage at the start of the superimposition of the alternating-current voltage and the direct-current voltage to such a value that is smaller than the duty ratio used for the image formation and will cause the superimposed voltage to fall within the leak voltages.

7. A high-voltage power supply device according to claim 6, wherein the duty ratio controller amplifies the duty ratio of the alternating-current voltage to the one used for the image formation from the one with which the voltage after the superimposition falls within the leak voltages within a predetermined period following the start of the superimposition of the alternating-current voltage and the direct-current voltage.

8. A high-voltage power supply device according to claim 6, wherein a diode is connected in series with the zener diode.

9. An image forming apparatus, comprising the high-voltage power supply devices according to claim 2 for the output of a high voltage as a developing bias.

10. An image forming apparatus, comprising the high-voltage power supply devices according to claim 6 for the output of a high voltage as a developing bias.

11. An image forming apparatus, comprising the high-voltage power supply devices according to claim 2 for the output of a charging high voltage.

12. An image forming apparatus, comprising the high-voltage power supply devices according to claim 6 for the output of a charging high voltage.
